(19) United States
(12) Patent Application Publication
(10) Pub. No.: US 2004/0112936 A1
(43) Pub. Date: Jun. 17, 2004

(54) Wire clamp

(75) Inventors: Leonard Lee Hixon JR., Lookout Mountain, GA (US); Randy Lomar Nunley, Signal Mountain, TN (US)

Correspondence Address: PARKHURST & WENDEL, L.L.P., 1421 PRINCE STREET, SUITE 210, ALEXANDRIA, VA, 22314-2805, US

(73) Assignee: Tennessee Rand Co., Inc., Chattanooga, TN

(21) Appl. No.: 10/639,761

(22) Filed: Aug. 13, 2003

Related U.S. Application Data
(60) Provisional application No. 60/406,626, filed on Aug. 29, 2002.

(51) Int. Cl. B23K 37/00

(52) U.S. Cl. 228/44.3; 228/4.5

(57) ABSTRACT

A wire clamp including a housing having a guide slot for receiving a wire, a first clamp arm rotatably mounted in the housing and having a first wire clamping surface, a second clamp arm rotatably mounted in the housing and having a second wire clamping surface, a bias means for applying a tension force between the first and second clamp arms, and an actuator cylinder for applying a pushing force against the first clamp arm. The second clamp arm, when receiving pressure from a wire inserted in the guide slot, rotates against the tension force toward a clamping position and thereby clamps such wire between the first and second wire clamping surfaces by the tension force. Activation of the actuator cylinder applies a pushing force against the first clamp arm to urge the first clamp arm to rotate against the tension force toward an open position so that an increased tension force simultaneously acting on the second clamp urges the second clamp to rotate toward an ejection position, thereby ejecting the wire.

### BACKGROUND OF THE INVENTION

The present application claims the benefit under 37 U.S.C. §119(e) of U.S. Provisional Application Serial No. 60/406,626, filed Aug. 29, 2002.

The present invention comprises an improved wire clamp for holding wires to be welded into assemblies such as seat frames, wire racks, and the like.

### BRIEF DESCRIPTION OF THE INVENTION

More particularly, the present invention comprises a mechanical wire clamp tool for receiving and holding a wire between two spring biased clamps, and for automatically ejecting the wire when a pneumatic cylinder is actuated to release at least one of said clamps.

The present invention is a compact, fully enclosed design that provides reliable performance under severe conditions encountered in welding environments. Such design can be further enhanced by coating a steel housing of the clamp with a spatter resistant coating for resisting welding spatter. The housing also facilitates reversible mounting of the clamp tool, and the mechanism provides automatic ejection of wire being held thereby.

### SUMMARY OF THE INVENTION

The present invention comprises a housing having an opening for receiving a wire, first and second clamp arms rotatably mounted in the housing the first clamp arm is located to rotate to substantially close the opening for receiving a wire and to clamp a wire inside the closed opening, and the second clamp arm has a clamping surface within the opening in the housing for receiving a wire. The present invention further comprises a bias means for applying a tension force between the first and second clamp arms and holding a wire in wire clamp, and release means for applying a pushing force against the first clamp arm thereby urging the first clamp arm toward a release position.

A second embodiment of the present invention is a wire clamp comprising a housing having a guide slot for receiving a wire, a first clamp arm rotatably mounted in the housing and having a first wire clamping surface and located to rotate to substantially close the guide slot, a second clamp arm rotatably mounted in the housing and having a second wire clamping surface below the guide slot and positioned to clamp a wire between the first wire clamping surface of the first clamp arm and the second wire clamping surface of the second arm, a bias means for applying a tension force between the first and second clamp arms, and an actuator cylinder for applying a pushing force against the first clamp arm to urge the first clamp arm to rotate against tension force from the bias means toward an open position and the increased tension force simultaneously acts on the second clamp arm to counter-rotate the second clamp arm to eject the wire. Activation of the actuator cylinder applies a pushing force against the first clamp arm to urge the first clamp arm to rotate against the tension force toward an open position so that an increased tension force simultaneously acting on the second clamp urges the second clamp to rotate toward an ejection position, thereby ejecting the wire.

A third embodiment of the present invention is the wire clamp according to the second embodiment, wherein the first clamp arm is located for receiving pressure from a wire inserted in the guide slot and thereby rotating against tension force from the bias means toward an open position, thereby opening the guide slot so that the wire enters the guide slot.

A fourth embodiment of the present invention is a wire clamp according to the second embodiment, wherein the first clamp arm is pivotally mounted in the housing a first pivot for rotation thereabout, and a first bias means attachment, the second clamp arm comprises a second pivot for rotation thereabout, and a second bias means attachment, whereby when the second clamp arm receives pressure from a wire inserted into the guide slot, the second clamp arm rotates, and tension force from the bias means causes the first clamp arm to rotate towards the second clamp arm.

A fifth embodiment of the present invention is the wire clamp according to the fourth embodiment, wherein the locations of the first pivot, the second pivot, and the bias means are such that tension force from the bias means causes the first wire clamping surface of the first clamp arm to travel across the guide slot outside of the position of a wire inserted in the guide slot, thereby firmly to hold a wire between the clamping surface of the first clamp arm and the clamping surface of the second clamping arm.

A sixth embodiment of the present invention is the wire clamp according to the fourth embodiment, wherein the location of the first pivot, the second pivot and the bias means are such that activation of the actuator cylinder applies a pushing force against the first clamp arm to urge the first clamp arm to rotate against the tension force from the bias means.

A seventh embodiment of the presently claimed invention is a wire clamp comprising a housing having a guide slot for receiving a wire; a first clamp arm pivotally mounted in the housing on a first pivot for rotation thereabout, and having a first wire clamping surface and located to rotate to substantially close the guide slot; a second clamp arm pivotally mounted in the housing on a second pivot for rotation thereabout, and having a second wire clamping surface within the guide slot and positioned to clamp a wire between the first wire clamping surface of the first clamp arm and the second wire clamping surface of the second clamp arm; first and second spring attachments; a spring for applying a tension force between the first and second clamp arms; and an actuator cylinder for applying a pushing force against the first clamp arm to urge the first clamp arm to rotate against tension force generated by the spring toward an open position and the increased tension force from the spring simultaneously acts on the second clamp arm to counter-rotate said second clamp arm to eject the wire. The second clamp arm, when receiving pressure from a wire inserted in the guide slot, will rotate against tension force from the spring toward a clamping position for clamping a wire between a clamping surface on the first clamp arm and a clamping surface on the second clamp arm. The first pivot and the first spring attachment are located on the first clamp arm and the second pivot and the second spring attachment are located on the second clamp arm so that when the second clamp arm receives pressure from a wire inserted in the guide slot, the second clamp arm rotates, and the tension from the spring causes the first clamp arm to rotate towards the second clamp arm. The locations of the first pivot, the first spring attachment, and the locations of the second pivot, and the second spring attachment are such that tension force from the spring causes the first wire clamping surface of the first clamp arm to travel across the guide slot outside of the position of a wire inserted in the guide slot, thereby firmly hold a wire between the clamping surface of the first clamp arm and the clamping surface of the second clamping arm. The location of the first pivot, and the first spring attachment and the location of the second pivot, and the second spring attachment are such that activation of the actuator cylinder applies a pushing force against the first clamp arm to urge the first clamp arm to rotate against the tension force from the spring.

### BRIEF DESCRIPTION OF THE DRAWINGS

The invention is further explained in conjunction with the following figures illustrating the present invention:

FIG. 1 is a schematic view of the wire clamp of the present invention;

FIG. 2 is a schematic view of the top side of the housing of the wire clamp shown in FIG. 1;

FIG. 3 is a schematic view of the bottom side of the housing of the wire clamp shown in FIG. 1;

FIG. 4a is a cutaway plan view showing the internal components of the wire clamp of the present invention in a release position;

FIG. 4b is a cutaway plan view showing the internal components of the wire clamp of the present invention in a clamp position;

FIG. 5 is a schematic view of the first clamp arm shown in FIG. 4;

FIG. 6 is a schematic view of the second clamp arm shown in FIG. 4; and

FIG. 7 is a schematic side view of a typical double acting air cylinder of the wire clamp shown in FIG. 1.

### DESCRIPTION OF THE PREFERRED EMBODIMENTS

The subject matter of the present invention is well depicted, and described in conjunction with, the drawings herewith.

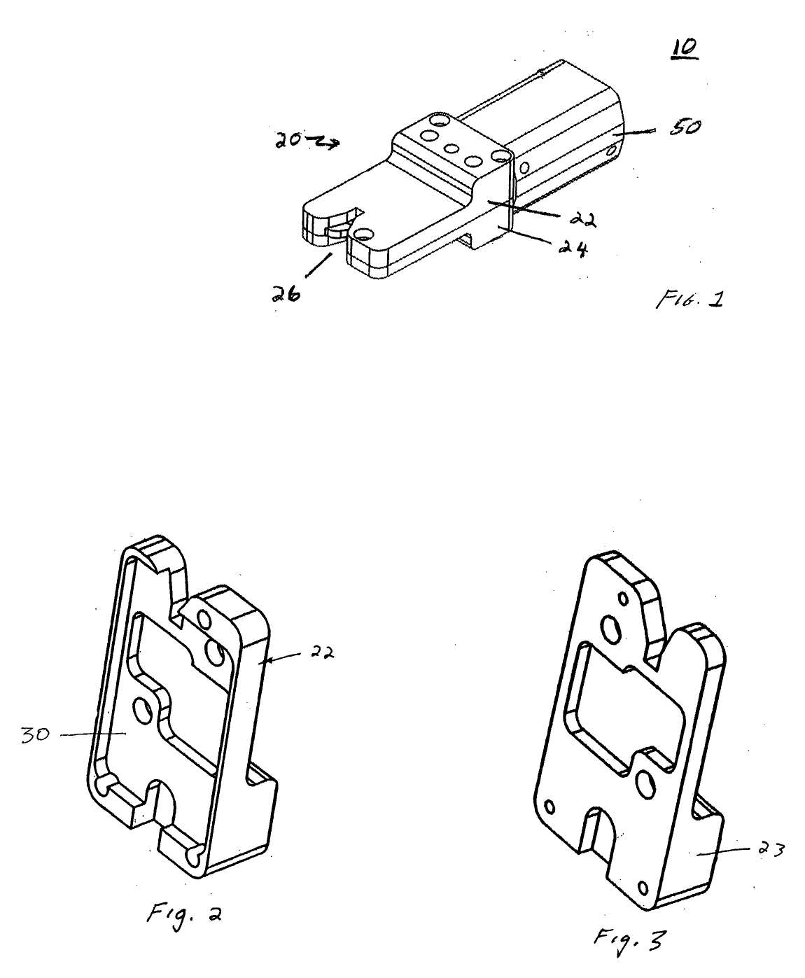

FIG. 1 shows a schematic view of the wire clamp assembly 10 of the present invention comprising a housing 20 and an actuator 50 attached to the housing 20. The housing 20 comprises a top side member 22 and a lower side member 24, which together define internal compartments of housing 20 and the guide slot 26.

FIG. 2 is a schematic view of the top side member 22 of housing 20 shown in FIG. 1, showing internal compartment 30. FIG. 3 is a schematic view of the lower side member 23 of housing 20 shown in FIG. 1.

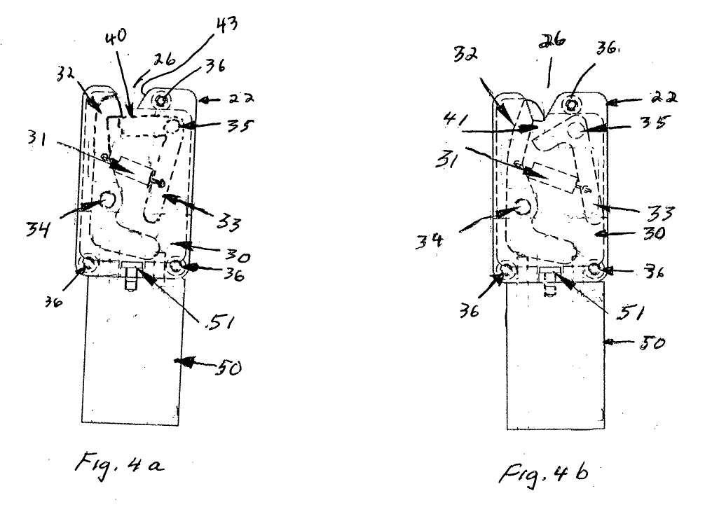

FIG. 4a is a cutaway plan view showing the internal components of the wire clamp 10 in a release position, and FIG. 4b is a cutaway plan view showing the components in a clamping position. The internal working mechanism of the wire clamp assembly 10 is located in the internal compartment 30, which houses spring 31 connecting a pivotable first clamp arm 32 to a pivotable second clamp arm 33, for cooperative movement described in greater detail later. Spring 31 is a means for generating a suitable force, such as, for example, a coil spring, a leaf spring, resilient arms, or a pneumatic cylinder, or the like. The spring 31 attaches to the first clamp arm 32 at the hole 31a, and to the second clamp arm 33 at the hole 31b, shown in FIGS. 5 and 6, respectively. The holes 31a, 31b are located to hold the spring 31 in a position to provide spring tension between the clamp arms during clamping and releasing actions, as described later. The first clamp arm 32 pivots on a cylindrical dowel 34 located in hole 34a (FIG. 5), and the second clamp arm 33 pivots on a cylindrical dowel 35 located in hole 35a (FIG. 6). Compartment 30 also includes suitable attachment hardware, such as, for example, three cap screws 36 shown in FIG. 4, for attaching top and bottom housings 22,23 together.

When assembled, the two housings 22,24 form a guide slot 26 into which a wire can be introduced for clamping. During use, a longitudinal portion of a wire to be clamped (not shown) is pushed into the guide slot 26 when clamp arms 32,33 are in a release position, as shown in FIG. 4a. The wire is pushed against the second clamp arm 33, causing that arm to rotate counter clockwise around pin 35. While the second clamp arm 33 is rotating counter clockwise away from the guide slot 26, the attached extension spring 31 increases in tension, thereby causing the first clamp arm 32 to rotate clockwise around pin 34 toward the slot and against the wire.

FIG. 5 is a schematic view of the first clamp arm 32 and FIG. 6 is a schematic view of the second clamp 33 arm. The first clamp arm 32 comprises cam surface 37 and clamping surfaces 38 and 39.

The cam surface 37 is for receiving an outer side surface of predetermined sizes of wire to be clamped. If such wire has a sufficiently large outer diameter to fill the guide slot 26 and also abut the housing surface 43, when manually forced by a user of the wire clamp, it will exert a pressure against guide surface 37, thereby causing counter-clockwise rotation of the upper arm 32, which further opens the throat of the guide slot 26, as necessary. If such wire diameter is small enough to pass by the cam surface 37, it will directly abut clamping surface 40 of lever 33, which will push surface 40 downward whereby the wire will move under surface 38 of the first clamp arm and the wire will be clamped between the clamping surface of the first clamp arm and the clamping surface of the second clamp arm.

When a user of the wire clamp manually forces a wire against clamping surface 40, the second clamp arm 33 rotates counter-clockwise. Simultaneously, the first clamp arm 32 rotates clockwise under tension of the spring 31 connecting arms 32 and 33. The second clamp arm 33 continues to rotate under pressure of the wire so that clamping surface 40 lowers with respect to clamping surface 38, thereby permitting clamping surface 38 to travel across the top outer surface of the wire and firmly draw the wire into a corner 41 between surfaces 38 and 39, while surface 40 of the second clamp arm 33 constantly presses upward. Thus, the wire is locked by the resultant force generated by the arms 32 and 33 and thereby held tightly under tension of the spring 31 in the corner 41 formed by surfaces 38 and 39. The wire, securely held by the first clamp arm 32 and the second clamp arm 33, remains clamped until the operator is ready to release the wire.

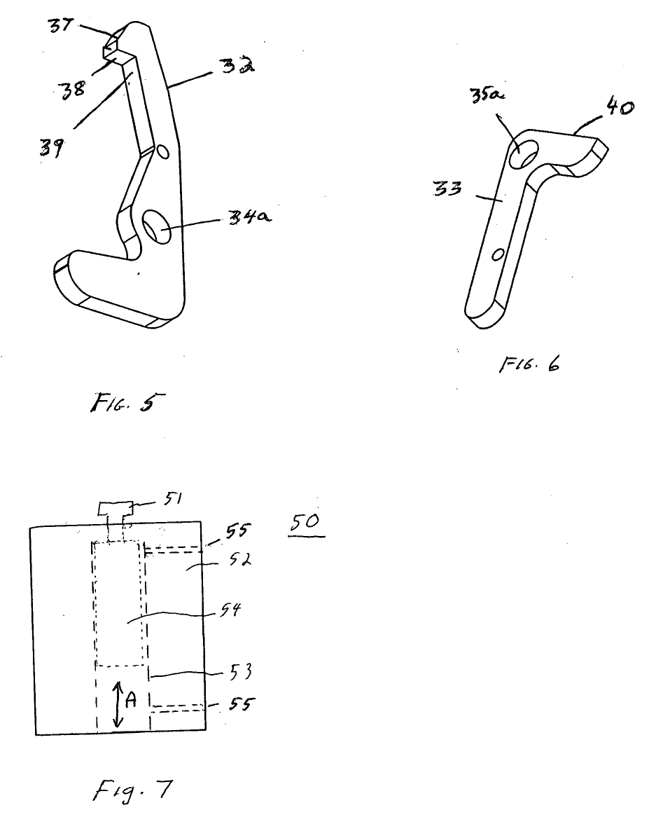

FIG. 7 is a schematic side view of a typical double acting air cylinder 50, which can be any suitable reciprocating power source. The double acting air cylinder 50 generally comprises a housing 52 with a bore 53 for slidably receiving a piston 54 attached to the headed shaft 51, wherein the piston 54 reciprocates in the direction of arrow A in response to gas pressure from a pneumatic source (not shown), via ports 55. The air cylinder 50 is attached to the housing 20 by any suitable means, such as, for example, cap screws.

Now referring to FIG. 4b, release of a wire is accomplished by energizing the actuator 50. This causes the headed shaft 51 to press against the first clamp arm 32, which drives the first clamp arm 32 in counter clockwise rotation away from the guide slot 26, so that the second clamp arm 33 is free to rotate clockwise under tension of the spring 31 and thereby eject a wire located in the guide slot 26.

Once the first clamp arm 32 rotates far enough away, the second clamp arm 33 ejects the wire out of the wire clamp assembly 10 due to the increased tension on the extension spring 31. The wire clamp assembly 10 is then ready to accept a new wire.

In the claims:

1. A wire clamp comprising:
a housing having an opening for receiving a wire;
first and second clamp arms rotatably mounted in the housing with the first clamp located to rotate to substantially close the opening and to clamp a wire inside the closed opening, and the second clamp arm having a clamping surface inside the housing near the opening;
bias means for applying a tension force between the first and second clamp arms to hold a wire in the wire clamp; and
release means for applying a pushing force against the first clamp arm thereby urging the first clamp arm toward a wire release position.

2. A wire clamp comprising:
a housing having a guide slot for receiving a wire;
a first clamp arm rotatably mounted in the housing and having a first wire clamping surface and located to rotate to substantially close the guide slot;
a second clamp arm rotatably mounted in the housing and having a second wire clamping surface inside the housing near the guide slot and positioned to clamp a wire between the first wire clamping surface of the first clamp arm and the second wire clamping surface of the second clamp arm;
bias means for applying a tension force between the first and second clamp arms;
the second clamp arm, which when receiving pressure from a wire inserted in the guide slot, will rotate against tension force from the bias means toward a clamping position for clamping a wire between a clamping surface on the first clamp arm and a clamping surface on the second clamp arm, and
an actuator cylinder for applying a pushing force against the first clamp arm to urge the first clamp arm to rotate against tension force from the bias means toward an open position and the tension force simultaneously acts on the second clamp arm to counter-rotate said second clamp arm to eject the wire.

3. The wire clamp according to claim 2, wherein the first clamp arm is located for receiving pressure from a wire inserted in the guide slot and causing the first clamp arm to rotate against tension force from the bias means toward an open position, thereby opening the guide slot to permit a wire to enter the guide slot.

4. The wire clamp according to claim 2, wherein:
the first clamp arm is pivotally mounted in the housing a first pivot for rotation thereabout,
the second clamp arm comprises a second pivot for rotation thereabout,
whereby when the second clamp arm receives pressure from a wire inserted into the guide slot, the second clamp arm rotates, and tension force from the bias means causes the first clamp arm to rotate towards the second clamp arm.

5. The wire clamp according to claim 4, wherein said locations of said first pivot, said second pivot, and said bias means are such that tension force from the bias means causes the first wire clamping surface of the first clamp arm to travel across the guide slot outside of the position for a wire to be inserted in the guide slot, thereby firmly to hold a wire between the clamping surface of the first clamp arm and the clamping surface of the second clamping arm.

6. The wire clamp according to claim 4, wherein said locations of said first pivot, said second pivot and said bias means are such that activation of the actuator cylinder applies a pushing force against the first clamp arm to urge the first clamp arm to rotate against the tension force from the bias means.

7. A wire clamp comprising:
a housing having a guide slot for receiving a wire;
a first L-shaped clamp arm pivotally mounted in the housing on a first pivot for rotation thereabout, and having a first wire clamping surface and located to rotate to substantially close the guide slot, said first wire clamping surface located on an outside of a short leg of said L-shaped clamp arm;
a second C-shaped clamp arm pivotally mounted in the housing on a second pivot for rotation thereabout, and having a second wire clamping surface located on an inside surface at one end of said second C-shaped clamp, said second wire clamping surface being within the housing near the guide slot and positioned to clamp a wire between the first wire clamping surface of the first clamp arm and the second wire clamping surface of the second clamp arm;
a spring applying a tension force between the first and second clamp arms; and
an actuator cylinder for applying a pushing force against the first clamp arm to urge the first clamp arm to rotate against tension force generated by the spring toward an open position, whereby tension force from the spring simultaneously acts on the second clamp arm to counter-rotate said second clamp arm to eject a wire, wherein
the second clamp arm, when receiving pressure from a wire inserted in the guide slot, will rotate against tension force from the spring toward a clamping position for clamping a wire between the first wire clamping surface on the first clamp arm and the second wire clamping surface on the second clamp arm,
said first pivot and said first spring are located along the first clamp arm, and said second pivot and said second spring are located along the second clamp arm so that when the second clamp arm receives pressure from a wire inserted in the guide slot, the second clamp arm rotates, and the tension from the spring causes the first clamp arm to rotate towards the second clamp arm,
said locations of said first pivot and said first spring, and said locations of said second pivot and said second spring, are such that tension force from the spring causes the first wire clamping surface of the first clamp arm to travel across the guide slot outside of the position of a wire to be inserted into the guide slot, thereby firmly to hold a wire between the first wire clamping surface of the first clamp arm and the second wire clamping surface of the second clamping arm, and
said location of said first pivot, and said first spring, said location of said second pivot and said second spring, are such that activation of the actuator cylinder applies a pushing force against the first clamp arm to urge the first clamp arm to rotate against the tension force from the spring.
